(19) United States
(12) Patent Application Publication
(10) Pub. No.: US 2024/0429532 A1
(43) Pub. Date: Dec. 26, 2024

(54) BATTERY PACK HAVING STRUCTURAL SUPPORT ASSEMBLY FOR ELECTRIFIED VEHICLE

(71) Applicant: FCA US LLC, Auburn Hills, MI (US)

(72) Inventors: Yuanxia Dong, Shanghai (CN); Zi Ye Wang, Shanghai (CN); Xingjia Li, Shanghai (CN); Junjun Kieran Ji, Shanghai (CN); Xiu Min Song, Shanghai (CN)

(21) Appl. No.: 18/340,302

(22) Filed: Jun. 23, 2023

(51) Int. Cl. H01M 50/262; H01M 10/613; H01M 10/6554

(52) U.S. Cl. CPC H01M 50/262; H01M 10/613; H01M 10/6554

(57) ABSTRACT

A battery pack assembly for an electrified vehicle includes a top cover, a cooling plate, a bottom plate and a main body assembly. The main body assembly comprises a structural frame support assembly having a front beam, a rear beam, a first side beam and a second side beam. A middle beam provides structural support to the cooling plate. A front support member is disposed at least partially between the cooling plate and the bottom plate. A rear support member is disposed at least partially between the cooling plate and the bottom plate. First structural glue is disposed between the front support member and the cooling plate.

### FIELD

The present application generally relates to electrified vehicles and, more particularly, to a battery pack incorporating a structural support assembly having extruded frame members and structural glue.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor.

The high voltage battery system generally includes a battery pack assembly that includes a housing that houses one or more battery packs or cells. Typically, the battery pack assembly includes a cooling system wherein a cooling liquid is circulated along a cooling plate for cooling the battery packs and the battery pack assembly. In some instances, vehicle vibration and/or impact loads experienced during driving can cause deformation of battery pack components including the cooling plate and the battery pack assembly as a whole. Accordingly, while such conventional battery pack assemblies do work well for their intended purpose, there exists an opportunity for improvement in the relevant art.

### SUMMARY

According to one example aspect of the invention, a battery pack assembly for an electrified vehicle includes a top cover, a cooling plate, a bottom plate and a main body assembly. The main body assembly comprises a structural frame support assembly having a front beam, a rear beam, a first side beam and a second side beam. A middle beam provides structural support to the cooling plate. A front support member is disposed at least partially between the cooling plate and the bottom plate. A rear support member is disposed at least partially between the cooling plate and the bottom plate. First structural glue is disposed between the front support member and the cooling plate.

In some implementations, the front support member provides structural support between the cooling plate and the bottom plate. The rear support member provides structural support between the cooling plate and the bottom plate. The first structural glue is configured to inhibit relative movement between the front support member and the cooling plate.

In some implementations, second structural glue is disposed between the front support member and the bottom plate. The second structural glue is configured to inhibit relative movement between the front support member and the bottom plate.

According to another example aspect of the invention, third structural glue is disposed between the rear support member and the cooling plate. The third structural glue is configured to inhibit relative movement between the rear support member and the cooling plate.

In some implementations, fourth structural glue is disposed between the rear support member and the bottom plate. The fourth structural glue is configured to inhibit relative movement between the rear support member and the bottom plate.

In some implementations, fifth structural glue is disposed between the middle beam and the cooling plate. The fifth structural glue is configured to inhibit relative movement between the middle mean and the cooling plate.

In other features, the front support member defines first insets for receiving the second structural glue. The rear support member defines second insets for receiving the fourth structural glue. The front and rear support members are formed of extruded aluminum.

In other implementations, a first fastener couples the front support member and the front beam. A second fastener couples the rear support member and the rear beam. A third fastener couples the cooling plate to one of the first side beam and the second side beam. The first, second and third fasteners are distinct. A fourth fastener couples the middle beam and the cooling plate. The fourth fastener is distinct from the first, second and third fastener.

A battery pack assembly for an electrified vehicle according to additional examples of the present disclosure includes a top cover, a cooping plate and a main body assembly. The main body assembly includes a structural frame support assembly that includes a middle beam, a front support member and a rear support member. The middle beam provides structural support to the cooling plate. The middle mean has structural glue disposed thereon that fixes the middle beam to the cooling plate. The front support member is disposed at least partially between the cooling plate and the bottom plate. The front support member provides structural support between the cooling plate and the bottom plate. The from support member has structural glue disposed thereon that fixes the front support member to the cooling plate and to the bottom plate. The rear support member is disposed at least partially between the cooling plate and the bottom plate. The rear support member provides structural support between the cooling plate and the bottom plate. The rear support member has structural glue disposed thereon that fixes the rear support member to the cooling plate and to the bottom plate.

In additional arrangements the front support member defines first insets for receiving the structural glue. The rear support member defines second insets for receiving the structural glue. The front and rear support members are formed of extruded aluminum. In other implementations, a first fastener couples the front support member and the front beam. A second fastener couples the rear support member and the rear beam. A third fastener couples the cooling plate to one of the first side beam and the second side beam. The first, second and third fasteners are distinct. A fourth fastener couples the middle beam and the cooling plate. The fourth fastener is distinct from the first, second and third fastener.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a battery system according to the principles of the present application;

FIG. 2 is partial exploded perspective view of a battery pack assembly of the battery system of FIG. 1 according to the principles of the present application;

FIG. 3 is a bottom perspective view of a main body assembly of the battery pack assembly of FIG. 2 according to the principles of the present application;

FIG. 4 is a top perspective view of the main body assembly of the battery pack assembly of FIG. 2 according to the principles of the present application;

FIG. 5 is a sectional view taken along lines 5-5 of the main body assembly of the battery pack assembly of FIG. 4;

FIG. 6 is a detail view of area 6 of the main body assembly of the battery pack assembly FIG. 5;

FIG. 7 is a detail view of area 7 of the main body assembly of the battery pack assembly FIG. 5;

FIG. 8 is a detail view of area 8 of the main body assembly of the battery pack assembly FIG. 5; and

FIG. 9 is an exploded view of a cooling plate assembly of the battery pack assembly of FIG. 2.

### DESCRIPTION

As discussed above, a high voltage battery system generally includes a battery pack assembly that includes a housing that houses one or more battery packs. Typically, the battery pack assembly includes a cooling system wherein a cooling liquid is circulated along a cooling plate for cooling the battery packs and the battery pack assembly. In some instances, vehicle vibration and/or impact loads experienced during driving of the vehicle can cause undesirable relative movements of components in a battery pack such as frame members and cooling plates. Over the life of a vehicle, such repeated vibrations experienced by the battery packs can lead to deformation of battery pack components including the cooling plate. Over time, such vibrations can ultimately lead to failure of one or more components of the battery pack such as a rupture of the cooling plate.

Accordingly, the structural frame support configuration of the battery pack of the instant disclosure incorporates aluminum extrusion support frames coated with structural glue at strategic areas to inhibit relative movements between adjacent components. In particular, the present disclosure provides an integrated design that ensures the transmission of vibration or impact loads in a more uniform manner mitigating any potential damage to the components of the battery pack including the cooling plate during the life of the vehicle. As a result, the overall anti-impact and vibration absorption ability of the battery pack as a whole is effectively enhanced.

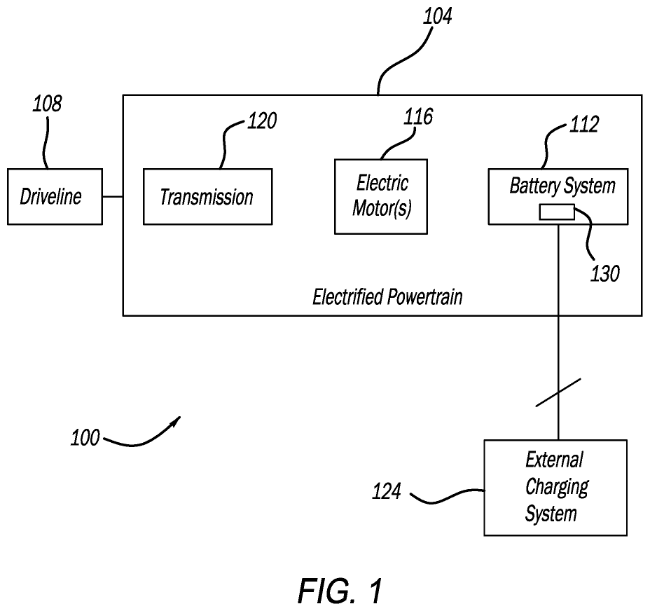

Referring now to FIG. 1, a functional block diagram of an example electrified vehicle 100 (also referred to herein as “vehicle 100”) according to the principles of the present application is illustrated. The vehicle 100 includes an electrified powertrain 104 configured to generate and transfer drive torque to a driveline 108 of the vehicle 100 for propulsion. The electrified powertrain 104 generally comprises a high voltage battery system 112 (also referred to herein as “battery system 112”), one or more electric motors 116, and a transmission 120. The battery system 112 is selectively connectable (e.g., by the driver) to an external charging system 124 (also referred to herein as “charger 124”) for charging of the battery system 112. The battery system 112 includes at least one battery pack assembly 130.

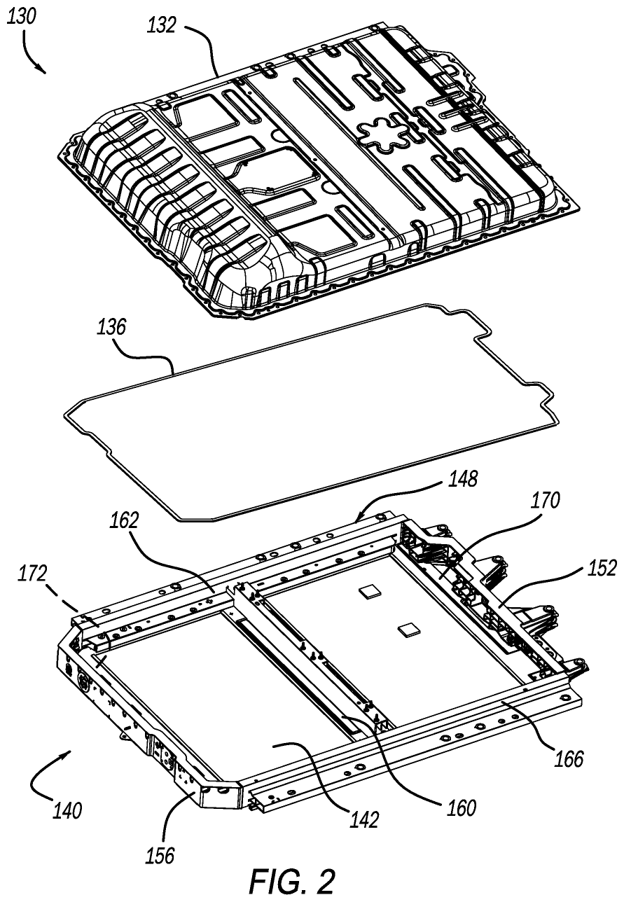

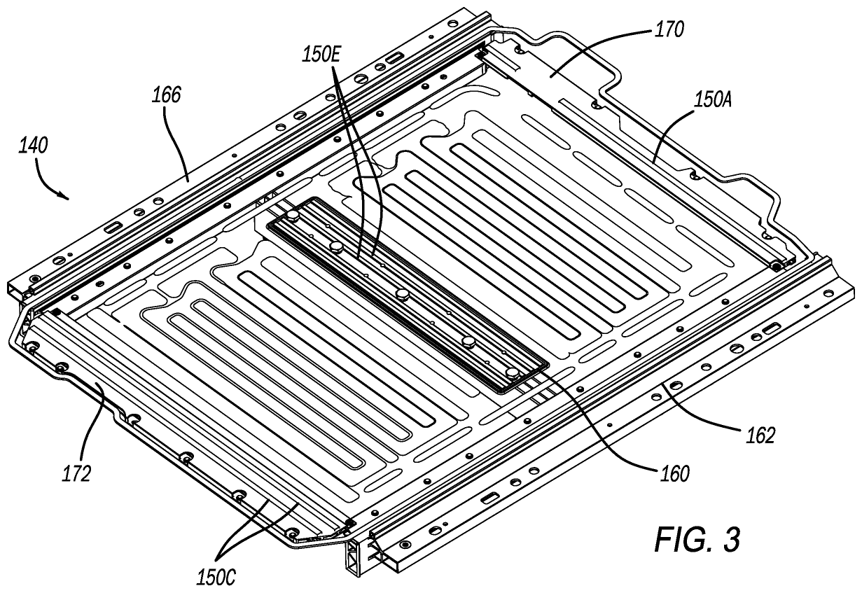

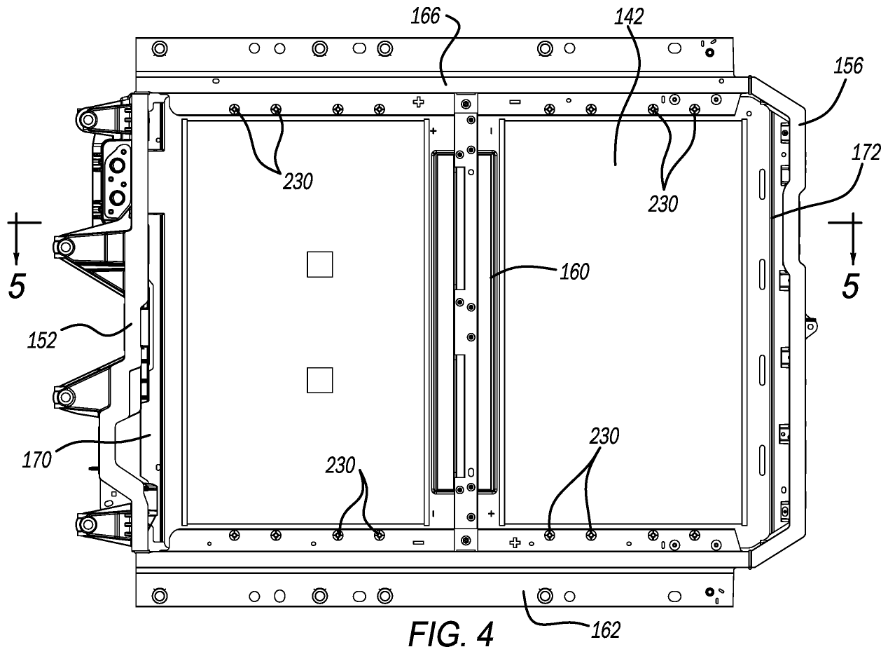

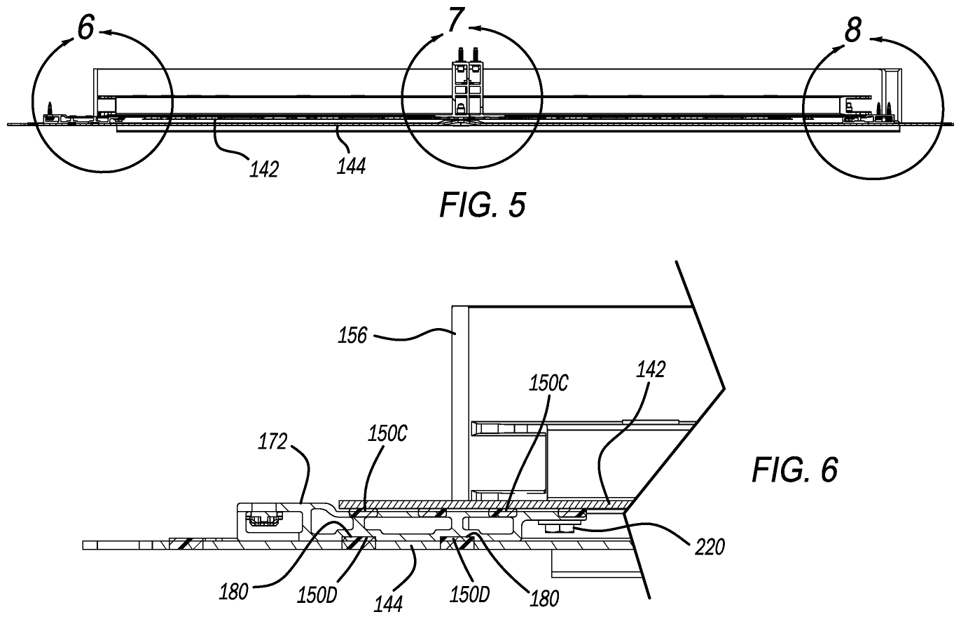

Referring now to FIGS. 2-8, the battery pack assembly 130 according to one example of the present disclosure will be described. The battery pack assembly 130 includes a top cover 132, an intermediate seal 136 and a main body assembly 140. Batteries, not specifically shown, are housed in the battery pack assembly 130 under the top cover 132. The main body assembly 140 further houses a cooling plate 142 and a bottom plate 144. The cooling plate 142 is configured to cool components of the battery pack assembly 130.

The main body assembly 140 of the battery pack assembly 130 according to some implementations of the present application generally includes a structural frame support assembly 148. The structural support frame assembly 148 can include a front beam 152, a rear beam 156, a middle beam 160, a first side beam 162 and a second side beam 166. The structural support assembly 148 can further include a front support member 170 and a rear support member 172.

As will be described herein, the front support member 170 is at least partially disposed between cooling plate 142 and the bottom plate 144 (see also FIG. 8). The front support member 170 provides structural support between the cooling plate 142 and the bottom plate 144. Structural glue 150A is disposed between the front support member 170 and the cooling plate 142. Structural glue 150B is also disposed between the front support member 170 and the bottom plate 144.

The front support member 170 is therefore bonded to the cooling plate 142 and the bottom plate 144 by the structural glue 150A and 150B. The front support member 170 provides physical support between the cooling plate 142 and the bottom plate 144 while the structural glue 150A and 150B inhibits relative movement and vibrations between the front support member 170, the cooling plate 142 and the bottom plate 144. As vibrations are not transmitted between the front support member 170, the cooling plate 142 and the bottom plate 144, the cooling plate 142 experiences minimal disruption and deformations during the life of the battery pack assembly 130.

The rear support member 172 is similarly disposed between the cooling plate 142 and the bottom plate 144 (see also FIG. 6). The rear support member 172 provides structural support between the cooling plate 142 and the bottom plate 144. Structural glue 150C is disposed between the rear support member 172 and the cooling plate 142. Structural glue 150D is also disposed between the rear support member 172 and the bottom plate 144.

The rear support member 172 is therefore bonded to the cooling plate 142 and the bottom plate 144. The rear support member 172 provides physical support between the cooling plate 142 and the bottom plate 144 while the structural glue 150C and 150D inhibits relative movement and vibrations between the rear support member 172, the cooling plate 142 and the bottom plate 144. As vibrations are not transmitted between the rear support member 172, the cooling plate 142 and the bottom plate 144, the cooling plate 142 experiences minimal disruption and deformations during the life of the battery pack assembly 130.

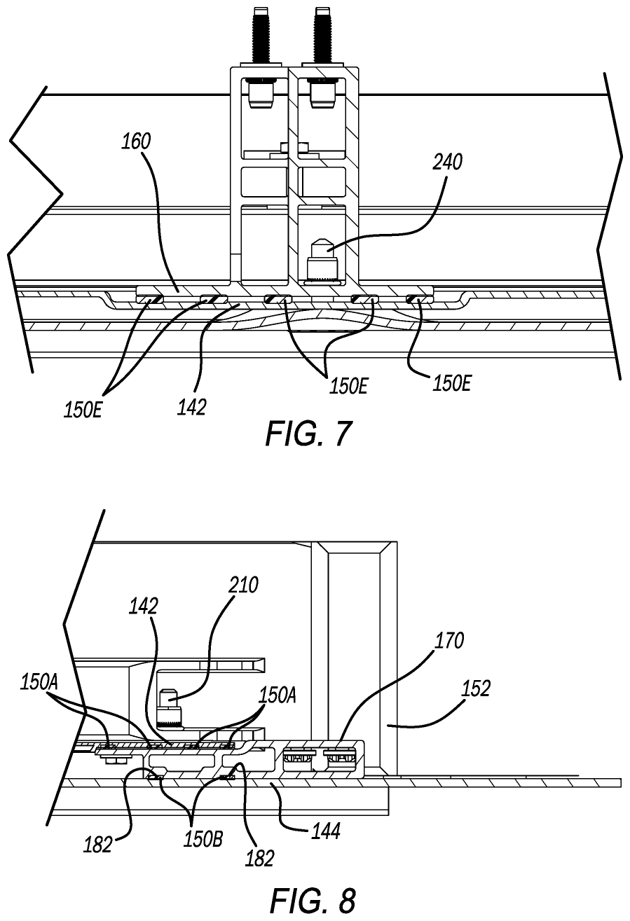

With reference now to FIG. 7, structural glue 150E is disposed between the middle beam 160 and the cooling plate 144. The middle beam 160 is therefore bonded to the cooling plate 144. Similar to the structural glue 150A-150D disposed between respective support members 170, 172, cooling plate 142 and bottom plate 144 described above, the structural glue 150E inhibits relative motion between the middle beam 160 and the cooling plate 144. The middle beam 160 further provides structural support to the cooling plate 142. In this regard, minimal vibrations are transmitted to the cooling plate 144 and to other components of the battery pack assembly 130 at the middle support 160.

The structural glue 150A-150E collectively cooperates to provide a more robust battery pack assembly 130 that is more equipped to mitigate vibrations experienced during operation of the electrified vehicle 100. In particular, the structural glue 150A disposed between the front support member 170 and the cooling plate 142, the structural glue 150B disposed between the front support member 170 and the bottom plate 144, the structural glue 150C disposed between the rear support member 172 and the cooling plate 142, the structural glue 150D disposed between the rear support member 172 and the bottom plate 144, and the structural glue 150E disposed between the middle beam 160 and the cooling plate 142 all minimize relative movement between the cooling plate 142, the bottom plate 144 and the structural support assembly 148.

In examples, the front and rear support members 170 and 172 can be formed of extruded aluminum. The structural glue 150A (FIG. 8) can be applied at any suitable location between the front support member 170 and the cooling plate 142. The structural glue 150B (FIG. 8) can be applied at any suitable location between the front support member 170 and the bottom plate 144. In one example, the front support member 170 can define insets 180 for receiving the structural glue 150B. The structural glue 150C (FIG. 6) can be applied at any suitable location between the rear support member 172 and the cooling plate 142. The structural glue 150D (FIG. 6) can be applied to any suitable location between the rear support member 172 and the bottom plate 144. In one example, the rear support member 172 can define insets 182 for receiving the structural glue 150D.

A first fastener 210 couples the front support member 170 and the front beam 152. A second fastener 220 couples the rear support member 172 and the rear beam 156. A third fastener 230 couples the cooling plate 142 to the first side frame member 162 and to the second side frame member 166. A fourth fastener 240 couples the cooling plate 142 to the middle beam 160. It is appreciated that while the first fastener 210 is referred to as a singular fastener, more than one first fastener 210 may be used to couple the front support member 170 and the front beam 152. Similarly, while the second fastener 220 is referred to as a singular fastener, more than one second fastener 220 may be used to couple the rear support member 172 and the rear beam 156. In addition, while the fourth fastener 240 is referred to as a singular fastener, more than one fourth fasteners 240 may be used to couple the cooling plate 142 to the middle beam 160. By using unique fasteners 210, 220 and 230 between the respective components, vibrations can be further diminished between the respective components.

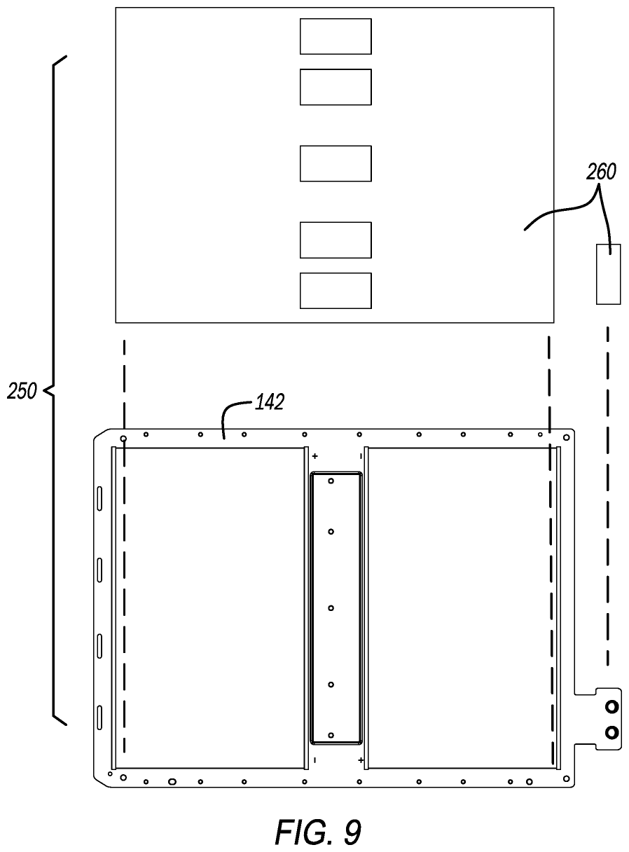

Referring to FIG. 9, a cooling plate assembly 250 is shown. The cooling plate assembly 250 includes the cooling plate 142 and a holding pad 260. In examples, the holding pad 260 can be formed of expanded polypropylene such as EPP90.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A battery pack assembly for an electrified vehicle, the battery pack assembly comprising:
a top cover;
a cooling plate;
a bottom plate; and
a main body assembly comprising a structural frame support assembly, the structural frame support assembly comprising:
a front beam, a rear beam, a first side beam and a second side beam;
a middle beam that provides structural support to the cooling plate;
a front support member disposed at least partially between the cooling plate and the bottom plate, the front support member providing structural support between the cooling plate and the bottom plate;
a rear support member disposed at least partially between the cooling plate and the bottom plate, the rear support member providing structural support between the cooling plate and the bottom plate; and
first structural glue disposed between the front support member and the cooling plate, the first structural glue configured to inhibit relative movement between the front support member and the cooling plate.

2. The battery pack assembly of claim 1, further comprising:
second structural glue disposed between the front support member and the bottom plate, the second structural glue configured to inhibit relative movement between the front support member and the bottom plate.

3. The battery pack assembly of claim 2, further comprising:
third structural glue disposed between the rear support member and the cooling plate, the third structural glue configured to inhibit relative movement between the rear support member and the cooling plate.

4. The battery pack assembly of claim 3, further comprising:
fourth structural glue disposed between the rear support member and the bottom plate, the fourth structural glue configured to inhibit relative movement between the rear support member and the bottom plate.

5. The battery pack assembly of claim 4, further comprising:
fifth structural glue disposed between the middle beam and the cooling plate, the fifth structural glue configured to inhibit relative movement between the middle beam and the cooling plate.

6. The battery pack assembly of claim 2 wherein the front support member defines first insets for receiving the second structural glue.

7. The battery pack assembly of claim 4 wherein the rear support member defines second insets for receiving the fourth structural glue.

8. The battery pack assembly of claim 1 wherein the front and rear support members are formed of extruded aluminum.

9. The battery pack assembly of claim 1, further comprising:
a first fastener that couples the front support member and the front beam;
a second fastener that couples the rear support member and the rear beam; and
a third fastener that couples the cooling plate to one of the first side beam and the second side beam, wherein the first, second and third fasteners are distinct.

10. The battery pack assembly of claim 9, further comprising:
a fourth fastener that couples the middle beam and the cooling plate, wherein the fourth fastener is distinct from the first, second and third fasteners.

11. A battery pack assembly for an electrified vehicle, the battery pack assembly comprising:
a top cover;
a cooling plate;
a bottom plate; and
a main body assembly comprising a structural frame support assembly, the structural frame support assembly comprising:
a middle beam that provides structural support to the cooling plate, the middle beam having structural glue disposed thereon that fixes the middle beam to the cooling plate;
a front support member disposed at least partially between the cooling plate and the bottom plate, the front support member providing structural support between the cooling plate and the bottom plate, the front support member having structural glue disposed thereon that fixes the front support member to the cooling plate and to the bottom plate; and
a rear support member disposed at least partially between the cooling plate and the bottom plate, the rear support member providing structural support between the cooling plate and the bottom plate, the rear support member having structural glue disposed thereon that fixes the rear support member to the cooling plate and to the bottom plate.

12. The battery pack assembly of claim 11 wherein the front support member defines first insets for receiving the structural glue.

13. The battery pack assembly of claim 11 wherein the rear support member defines second insets for receiving the structural glue.

14. The battery pack assembly of claim 11 wherein the front and rear support members are formed of extruded aluminum.

15. The battery pack assembly of claim 11, further comprising:
a first fastener that couples the front support member and a front beam;
a second fastener that couples the rear support member and a rear beam; and
a third fastener that couples the cooling plate to one of the first side beam and the second side beam, wherein the first, second and third fasteners are distinct.

16. The battery pack assembly of claim 15, further comprising:
a fourth fastener that couples the middle beam and the cooling plate, wherein the fourth fastener is distinct from the first, second and third fasteners.
